(19) United States
(12) Patent Application Publication
(10) Pub. No.: US 2004/0205709 A1
(43) Pub. Date: Oct. 14, 2004

(54) Method,system, and program for providing patch expressions used in determining whether to install a patch

(75) Inventors: Daniel K. Hiltgen, Los Gatos, CA (US); Julian S. Taylor, Nederland, CO (US)

Correspondence Address: LAHIVE & COCKFIELD, LLP., 28 STATE STREET, BOSTON, MA, 02109, US

(73) Assignee: Sun Microsystems, Inc.

(21) Appl. No.: 09/852,070

(22) Filed: May 9, 2001

(51) Int. Cl. G06F 9/455; G06F 9/44

(52) U.S. Cl. 717/115; 717/168; 717/174

(57) ABSTRACT

Provided is a method, system, and program for creating a patch including content to apply to a computer. A set of conditional statements is provided that return a boolean response based on a presence of a software or hardware component indicated in a computer object for the computer on which the patch will be applied. A patch attribute statement is called with at least one conditional statement that returns a list of one or more patches if the at least one conditional statement evaluates as true. An attribute defined for the attribute statement is associated with the installation of the patch to the computer if the computer includes the returned list of patches. A script program is provided including at least one patch attribute statement. The script program is provided with the patch, wherein the script program executes and processes a computer object including information on installed software and hardware components determined in the computer to determine whether the at least one conditional statement associated with each patch attribute statement is true.

### CROSS REFERENCE TO RELATED APPLICATIONS

This patent application is related to the following co-pending and commonly assigned patent applications filed on the same date herewith, and which are incorporated herein by reference in their entirety:

“Method, System, Program, and Data Structures For Applying a Patch to a Computer System”, having attorney docket no. P6141;

“Method, System, Program, and Data Structures For Using a Database to Apply Patches to a Computer System”, having attorney docket no. P6139.

### BACKGROUND OF THE INVENTION

1. Field of the Invention

The present invention relates to a method, system, and program for providing patch expressions used in determining whether to install a patch.

2. Description of the Related Art

In the prior art, to update or upgrade installed programs, a computer user would typically electronically access a vendor server site over a network, such as the Internet, and download the needed programs. Certain software vendors, such as Microsoft Corporation, provide an update program downloaded from Microsoft's web site that runs locally on the user computer, determines installed components, and presents updates the user may select to apply without transmitting any system information to Microsoft. The computer user may select suggested updates to download from the Microsoft web site. Such prior art techniques for locally analyzing the system and determining upgrades to apply are limited in that they perform only basic checking of installed components and require the execution of a program that interrogates system files each time updates are requested.

Moreover, prior art installation and updating programs, such as the Microsoft** online update program and the Setup Factory** installation program utilize commands and code that execute in the general operating system environment and are capable of accessing general system resources. Such an open architecture for applying updates and installations raises security concerns because the software vendor providing the update may inadvertently or malevolently access or modify system configuration information, data, and restricted data. Such security concerns are further heightened for update and installation packages provided by software vendors that are not known and trusted entities. **Java and Solaris are trademarks of Sun Microsystems, Inc. Intel and Pentium II are trademarks of Intel Corporation; Microsoft is a trademark of the Microsoft Corporation; and Setup Factory is a trademark of the Indigo Rose Software Design Corporation.

Software vendors also make updates and fixes available through their web sites. The user typically accesses the software vendor's web site and then will attempt to ascertain what fixes and updates are needed by reading documentation on the web site. In such cases, the application of updates is based on the specific knowledge of the user of the host computer, which in many cases may be inadequate to correctly determine and select the appropriate updates and fixes to apply given the current system status.

For these reasons, there is a need in the art to provide improved techniques for determining system configuration information and applying program fixes and updates to the system.

### SUMMARY OF THE PREFERRED EMBODIMENTS

Provided is a method, system, and program for creating a patch including content to apply to a computer. A set of conditional statements is provided that return a boolean response based on a presence of a software or hardware component indicated in a computer object for the computer on which the patch will be applied. A patch attribute statement is called with at least one conditional statement that returns a list of one or more patches if the at least one conditional statement evaluates as true. An attribute defined for the attribute statement is associated with the installation of the patch to the computer if the computer includes the returned list of patches. A script program is provided including at least one patch attribute statement. The script program is provided with the patch, wherein the script program executes and processes a computer object including information on installed software and hardware components determined in the computer to determine whether the at least one conditional statement associated with each patch attribute statement is true.

In further implementations, the patch attribute statement is capable of comprising: a patch requires statement, wherein the patch requires attribute indicates that the patches in the returned patch list must be installed in the computer in order for the patch to be installed in the computer; a patch incompatible statement, wherein the patch incompatible attribute indicates that if the patches in the returned patch list are installed in the computer, then the patch cannot be installed in the computer; and a patch prefers statement, wherein the patch prefers attribute indicates that the patches in the returned patch list are recommended to be installed in the computer.

Still further, the conditional and patch attribute statements may utilize a syntax that is similar to a syntax of commands capable of being interpreted by the computer operating system. The syntax of the conditional and patch attribute statements prevent the conditional and patch attribute statements from executing on the computer outside of a patch update interpreter that is capable of interpreting the syntax of the conditional and patch attribute statements.

### BRIEF DESCRIPTION OF THE DRAWINGS

Referring now to the drawings in which like reference numbers represents corresponding parts throughout:

FIG. 1 illustrates a computer architecture in which aspects of the invention are implemented;

FIG. 2 illustrates components within a realization detector and the host object, and their interaction, in accordance with certain implementations of the invention;

FIG. 3 illustrates a data structure of a realization in accordance with certain implementations of the invention;

FIG. 4 illustrates a data structure of an entry in a realization list in the host object in accordance with certain implementations of the invention;

FIGS. 5, 6, 7a, 7b, and 8 illustrate logic to apply code from patches to a host system in accordance with certain implementations of the invention;

FIG. 9 illustrates a network computer architecture in which aspects of the invention are implemented; and

FIG. 10 illustrates attribute statements that may be included with patch expressions.

### DETAILED DESCRIPTION OF THE DESCRIBED IMPLEMENTATIONS

In the following description, reference is made to the accompanying drawings which form a part hereof, and which illustrate several embodiments of the present invention. It is understood that other embodiments may be utilized and structural and operational changes may be made without departing from the scope of the present invention.

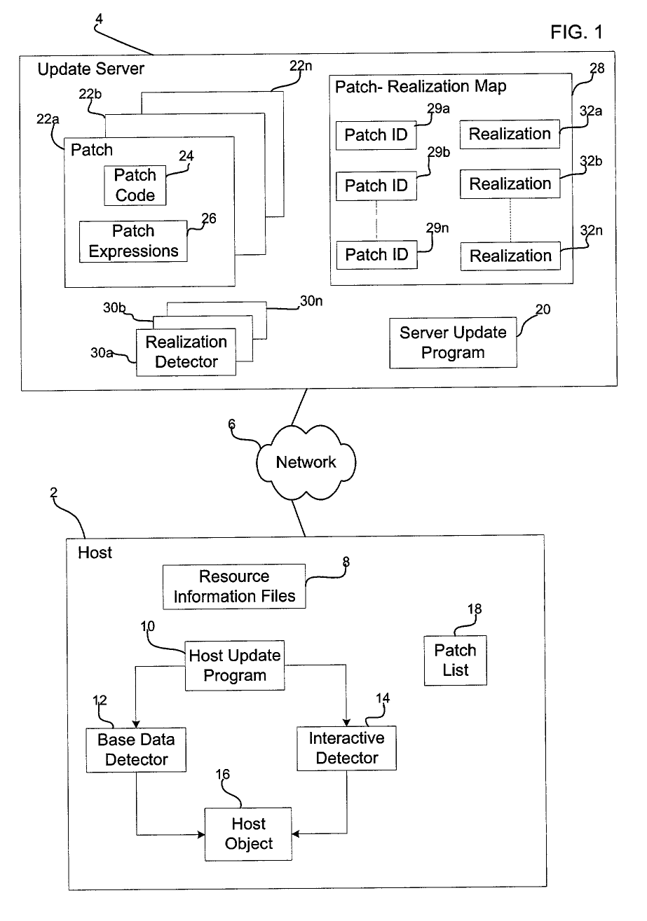

FIG. 1 illustrates a network computing environment in which aspects of the invention are implemented. A host computer 2 and server computer 4 communicate over a network 6, such as a Local Area Network (LAN), Wide Area Network (WAN), the Internet, an Intranet, etc., using any network protocol known in the art, e.g., Ethernet, Fibre Channel, TCP/IP, HyperText Transfer Protocol (HTTP), File Transfer Protocol (FTP), etc. The host 2 includes one or more resource information files 8 that provide tables, databases or other data structures providing information on installed system hardware and software resources, such as registry files or any other files. The host 2 further includes a host update program 10 that includes program code and modules to handle the update related operations in the host 2, including the base data detector 12 and interactive detector 14 that interrogate and determine host configuration information to use when generating a host object 16 that provides information on installed software packages, applied patches, firmware revisions, and any other software and/or hardware resource configuration on the host 2.

The server 4 includes a server update program 20 that handles requests for updates from the host 2 and a plurality of patches 22a, b . . . n. Each patch 22a, b . . . n includes patch code 24, which comprises the update or program fix to add to software or firmware installed on the host 2 or on a device attached to the host, e.g., a disk drive, tape drive, etc. An upgrade is an installation that changes the version number of the product, which often involves adding functionality to the program. A fix (also known as an update) comprises one or more software modules to add to an installed software program that does not add or remove any functionalty, but merely fixes a known problem or bug. Additionally, the patch 22a, b . . . n may provide any other types of content to add to the host 2, such as new program installations or documentation. Each patch 22a, b . . . n also includes one or more patch expressions 26 of script commands executed by the host update program 10 to evaluate certain conditions in the host object 16 and determine whether or in what manner the patch code 24 for the patch 22a, b . . . n is capable of being applied to the host 2 given the information on the host configuration maintained in the host object 16. Further details of the structure of the patch expressions 26 are described below.

The update server 4 further includes a patch-realization map 28 indicating how realizations are associated with the patches 22a, b . . . n. The map 28 provides an association of unique patch identifiers (IDs) 29a, b . . . n of the patches 22a, b . . . n and realizations 32a, b . . . n, which may have a many-to-may relationship. The map 28 may be implemented as a table of associations or as one or more database tables. A realization 32a, b . . . n, described below, is a data structure indicating a particular host state. For instance, if the patch 22a, b . . . n is used to fix a known bug, then the realizations 32a, b . . . n associated with that patch 22a, b . . . n in the patch-realization map 28 would indicate the state corrected by the patch 22a, b . . . n. The update server 4 also includes one or more realization detectors 30a, b . . . n that are downloaded to the host 2 to write realizations 30a, b . . . n to the host object 16

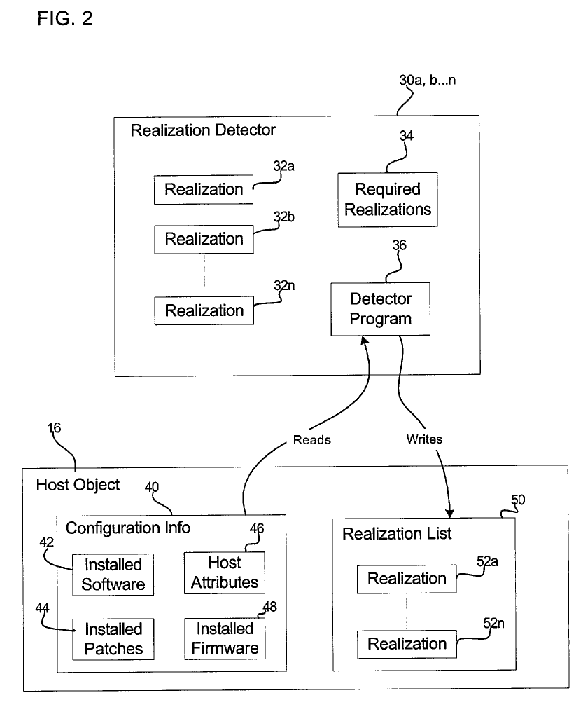

FIG. 2 illustrates how the realization detectors 30a, b . . . n interact with the host object 16. The realization detectors 30a, b . . . n are capable of identifying one or more realizations 32a, b . . . n that are associated with one or more of the patches 22a, b . . . n according to the patch-realization map 28. The realizations 32a, b . . . n comprise registered well-defined versioned strings, each of which identifies a specific state of the host system 2, such as the presence of one or more hardware and/or software resource. Thus, a realization 32a, b . . . n is associated with a particular state of the host 2. The realization detectors 30a, b . . . n further include a required realization variable 34 indicating the realization name and version number of base realizations in other realization detectors 30a, b . . . n that must be verified in the host object 16 in order for the dependent realization detector 32a, b . . . n to complete. Thus, a dependent realization 32a, b . . . n requires the presence of one or more base realizations in the host object 16, placed there by the execution of a previous realization detector 30a, b . . . n. Moreover, the realizations 32a, b . . . n within one realization detector 30a, b . . . n may be organized in an order such that any realizations dependent on a base realization 32a, b . . . n within the same realization detector 30a, b . . . n are processed after the base realizations from which they depend. Still further, the realization detectors 30a, b . . . n may be organized so that those detectors 30a, b . . . n including base realizations 32a, b . . . n are processed before realization detectors 30a, b . . . n including realizations 32a, b . . . n dependent therefrom. The realization detectors 30a, b . . . n include a detector program 36 that executes on the host 2 and analyzes information in the host object 16 to determine whether the state associated with the realizations 32a, b . . . n exists on the host 2.

FIG. 2 illustrates that the host object 16 includes configuration information 40, written by the base data detector 12 and/or interactive detector 14, such as information on installed software 42, installed patches 44, host attributes 46 (e.g., host 2 architecture, operating system, manufacturer, directly attached devices, etc.), and installed firmware 48. The detector program 36 reads the configuration information 40 and based thereon writes any number or no realizations 32a, b . . . n associated with the realization detector 30a, b . . . n to the host object 16. The host object 16 further includes a host realization list 50 of realization entries 52a, b . . . n written by the detector program 36, indicating realization states detected on the host 2. When determining whether the state associated with a realization 32a, b . . . n exists in the host 2, the detector program 36 may consider configuration information 40 and/or realizations 32a, b . . . n previously written to the host object 16 realization list 50

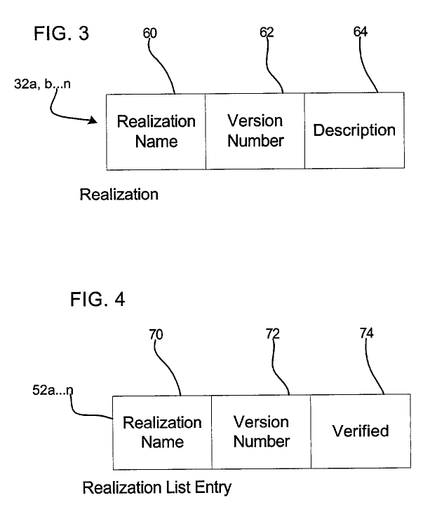

FIG. 3 illustrates the fields in the realizations 32a, b . . . n maintained in the patch-realization map 28, which associates patch IDs 29a, b . . . n with realizations 32a, b . . . n. The realizations 32a, b . . . n in the patch-realization map 28 include:

Realization name 60: comprises a unique identifier for a particular realization 30a, b . . . n.

Version number 62: indicates a version of a particular realization. As new versions of realizations are released, the version number is incremented indicating the number of version changes.

Description 64: provides a brief free format description of the realization or state being checked, e.g., a couple of hundred ASCII characters.

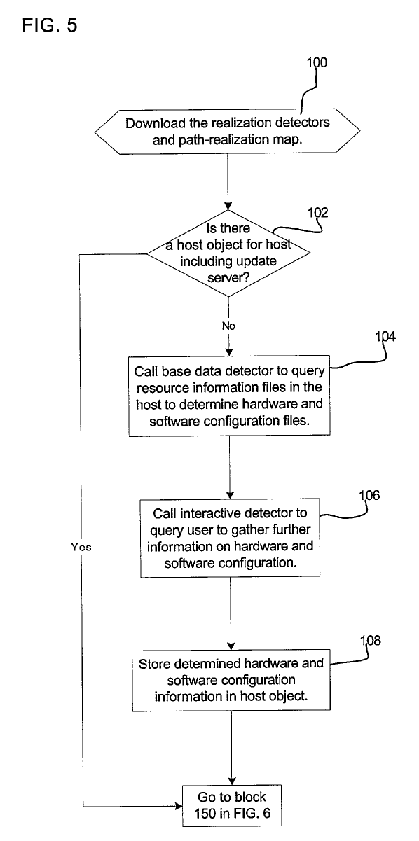

FIG. 4 illustrates the format of realization entries 52a, b . . . n in the host realization list 50 in the host object 16 written by the detector programs 36, including the realization name 70 and version number 72, which would be the realization name 60 and version number 62 maintained in the realizations 32a, b . . . n in the patch-realization map 28. A realization list entry 52a, b . . . n further includes a verified flag 74 indicating whether the detector program 36 returned true for the checked realization, i.e., the state checked by the detector program 36 exists in the host object 16, or false, i.e., the state does not exist in the host 2 according to information in the host object 16.

The detector program 36 may include one or more of the following methods that query the host object 16 for information on the availability of particular configuration information 40 and realizations:

is OperatingSystem: returns true if the target host 2 operating system as indicated in the host object 16 is the same as the specified operating system (OS), else returns false.

isOSRelease: returns true if the target host 2 operating system as indicated in the host object 16 is of the specified release, else returns false.

isPlatform: returns true if the target host 2 hardware platform as indicated in the host object 16 is the same as the specified platform, else returns false.

isArchitecture: returns true if the target host 2 processor architecture as indicated in the host object 16 is the same as the specified processor architecture, else returns false.

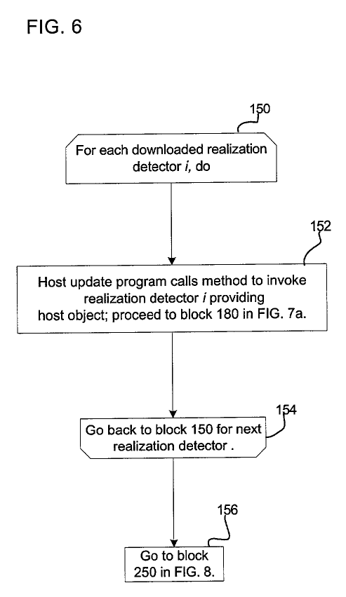

verifyRealization: verifies that the verified flag 56 (FIG. 5) in a realization entry 60 in the realization list 52 is true, i.e, the state checked by the realization exists on the host 2.

hasExactRealiation: returns true if the target host object 16 has a realization 30a, b . . . n in the realization 52 list having same realization name 50 and same version number 42 as specified realization.

hasRealization: returns true if the target host object 16 has a realization 30a, b . . . n in the realization 52 list having same realization name 50 and same or newer version number 42 as specified realization.

hasExactSoftwarePackage: returns true if the target host object 16 has an installed software package having the same name and version number as specified software package.

hasSoftwarePackage: returns true if the target host object 16 has an installed software package having the same name and a same or newer version number as specified software package.

hasExactPatchID: returns true if the target host object 16 has an installed patch having the same name and a same version number as specified patch ID.

hasPatchID: returns true if the target host object 16 has an installed patch having the same name and a same or newer version number as specified patch ID.

The detector program 36 may include combinations of one or more of the above methods to determine a state of the host 2 with respect to installed hardware and software components from the configuration information 40 and realization entries 52a, b . . . n included in the host realization list 52. The state determined by the detector program 36 may indicate whether an update is not likely to operate on the host 2 system. Additionally, when the patch code 24 comprises a fix, such as code to eliminate a bug, the state determined by the detector program 36 may indicate whether the configuration of the host 2 is particularly susceptible to the bug the patch code 24 is intended to fix.

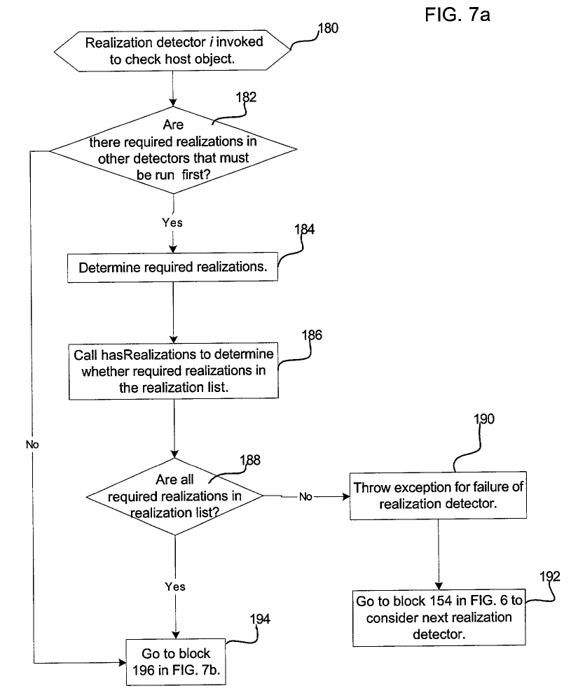

FIG. 5 illustrates logic executed in the host update program 10 to construct a host object 16 that defines the hardware and software configuration of the host 2. Control begins at block 100 with the host update program 10 downloading the patch-realization map 28 identifying patches 22a, b . . . n and one or more associated realizations 32a, b . . . n and the realization detectors 30a, b . . . n. If (at block 102) there already exists a host object 16 for the host 2, then control proceeds to block 150 in FIG. 6; otherwise, the host update program 10 calls (at block 104) the base data detector 12 to query the resource information files 8 to determine the software and hardware configuration existing on the host 2. The host update program 10 may further call (at block 104) the interactive detector 14 to present the user with questions regarding otherwise undetectable software and hardware configurations. Through this user interface the user may select to specify the configuration of the host 2. For instance, the user interface may display check boxes and/or drop down menus of different hardware and software configuration components which the user may select to define the hardware and software configuration of the host 2 system. The determined or entered software and hardware configuration information is then stored in the host object 16 with the configuration information 40. In certain embodiments, the host update program 10 may only call the base data detector 12 to initialize the host object 16. Alternatively, the host update program 10 may only call the interactive detector 14 to initialize the host object 16 with hardware and/or software configuration information entered by the user through a user interface. Still further, both the base data detector 12 and interactive detector 14 may be called to both provide hardware and software configuration information to the host object 16.

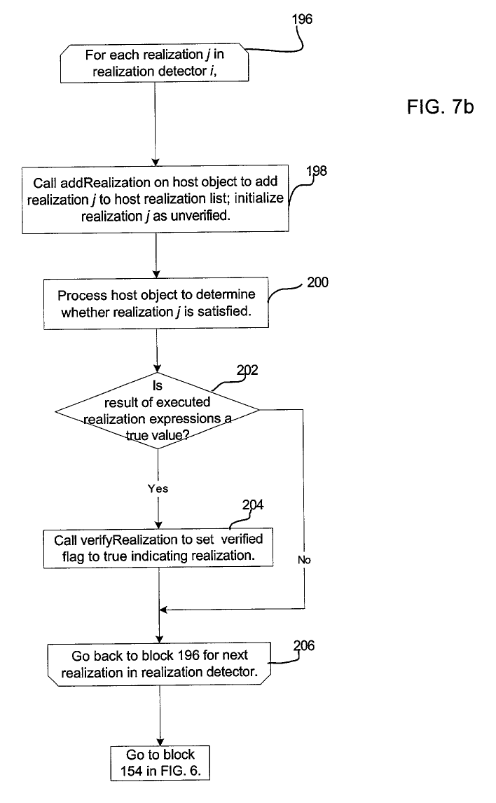

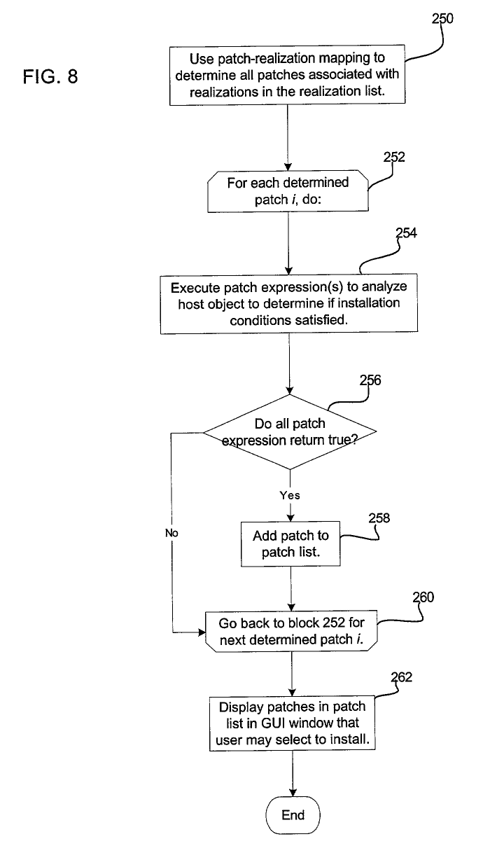

FIGS. 6 and 8 illustrate logic implemented in the host update program 10 to call the realization detectors 30a, b . . . n to determine patches that can be applied to the host 2. Once the host object 16 is initialized with configuration information from the base data detector 12 and/or interactive detector 14, control proceeds to block 150 in FIG. 6 where the host update program 10 performs a loop at blocks 150 to 154 for each downloaded realization detector i. At block 152, the host update program 10 calls a method to invoke the realization detector i providing the host object 16. Control then proceeds to block 180 in FIG. 7a.

FIGS. 7a, b illustrate logic implemented in the detector program 36 to verify the presence of states defined by realizations 32a, b . . . n associated with the realization detector i. At block 180 in FIG. 7a, the realization detector i is invoked by the host update program 10 to perform blocks 182 through 206 to execute the one or more realizations 30a, b . . . n within the realization detector i. The detector program 36 calls a method, hasRealizations, to determine (at block 182) whether there are any required realizations 34 (FIG. 2) that must be included in the host realization list 50 by other realization detectors 30a, b . . . n in order for the realization detector i to determine its own realizations 32a, b . . . n. If there are required realization 34, then the detector program determines (at block 184) the required realizations and calls (at block 186) the method hasRealizations to determine whether the required realizations are in the realization list 50 of the host object 2. If (at block 188) all the required realizations 52a, b . . . n are in the host realization list 50 or if there are no required realizations, then control proceeds (at block 194) to block 196 in FIG. 7b where the detector program 36 performs a loop of steps 198 to 204 for each realization j checked by the realization detector i to register the realizations 32a, b . . . n with the host object 16.

At block 198, the detector program 36 calls the addRealization on the host object 16 to add realization j to the host object 16 and initialize the realization j as unverified, i.e., sets the verified flag 74 (FIG. 4) to false. The detector program 36 then processes (at block 200) the host object 16 to determine whether the realization j is satisfied, i.e., the state defined by the realization j exists in the host 2. The detector program 36 may determine whether certain hardware and/or software components are installed as indicated in the configuration information 40 (FIG. 2) and/or consider status of realizations 52a, b . . . n already registered in the realization list 50. If (at block 202) the result of the realization j is verified, then the detector program 36 calls (at block 204) the verifyRealization method to set the verified flag 74 for the realization j in the realization list 50 to true; otherwise, the verified flag 74 remains false. From block 202 or 204, control proceeds (at block 206) back to block 296 to consider the next realization 32a, b . . . n in the realization detector i until all realizations are processed. After all realizations 32a, b . . . n for the realization detector i are considered, control proceeds (at block 208) to back to block 154 in FIG. 6 to process the next downloaded realization detector 30a, b . . . n

If (at block 188) the realization list 50 did not include all required realizations, then the detector program 36 would throw (at block 190) an exception indicating a failure of the realization detector i. From block 190 or 204, control proceeds (at block 192) back to block 154 in FIG. 6 to consider the next downloaded realization detector i. After processing (at block 154) all the downloaded realization detectors 30a, b . . . n, control proceeds (at block 156 in FIG. 6) to block 250 in FIG. 8.

FIG. 8 illustrates logic implemented in the host update program 10 to generate a patch list 18 which comprises the patches to present to the user for selection to install on the host 2. At block 250, the host update program 10 uses the patch realization mapping 28 to determine all patch IDs 29a, b . . . n associated with realizations 32a, b . . . n written to the host realization list 50 after processing the downloaded realization detectors 30a, b . . . n. A loop is performed at block 252 to 262. At block 254, the host update program 10 executes the patch expression(s) 26 to analyze the host object 16 to determine whether the host 2 includes specified software and/or hardware components and/or whether specific realizations 52a, b . . . n in the realization list 50 have been verified. If (at block 254) the patch expression 28 returns true, then the host update program 10 adds (at block 256) the patch i to the patch list. From block 258 or the no branch of block 256, if the patch expression returns false, i.e., the patch expression 28 conditions are not satisfied, control proceeds (at block 260) back to block 252 to consider the next downloaded patch 22a, b . . . n.

After all patches have been considered, the host update program 10 displays a user interface listing all the patches in the patch list to allow the user to select one or more patches 22a, b . . . n from the patch list to install by executing the patch code 24 for such selected patches 22a, b . . . n. The host update program 10 may download the patch code 24 for the patches 22a, b . . . n selected from the patch list 18 to conserve network bandwidth because only the patch code for user selected patches 22a, b . . . n are downloaded and installed.

The architecture described herein allows software vendors who provide patches for their installed products to make patches available on an update server 4. The described implementations provide a technique where the patch itself is able to determine whether the patch installation is compatible with the host 2 configuration. The realization detectors 30a, b . . . n are able to verify the capabilities of the host 2 indirectly through a host object 16. In certain described implementations, the only modification the detector programs 36 included with the realization detector 30a, b . . . n may make is to write verification information to the realization list 52 in the host object 16. These restrictions on the access provided to the realization detectors 30a, b . . . n protects the host system 2 from the realization detector 30a, b . . . n inadvertently or malevolently performing harmful operations on the host system 2.

In the above described implementations, the realization detectors 30a, b . . . n are downloaded and executed on the host 2 on which the patches 22a, b . . . n will be applied. The host update program 10 may comprise a program the host 2 temporarily downloads, such as a Java Applet**, to generate the host object 16 and determine patches 22a, b . . . n that may be applied. Additionally, the host update program 10 may comprise a stand alone program permanently installed on the host 2 that periodically checks the update server 4 for new patches 22a, b . . . n to present to the user to enable the host 2 user to apply the new patches 22a, b . . . n. **Java and Solaris are trademarks of Sun Microsystems, Inc. Intel and Pentium II are trademarks of Intel Corporation; Microsoft is a trademark of the Microsoft Corporation; and Setup Factory is a trademark of the Indigo Rose Software Design Corporation.

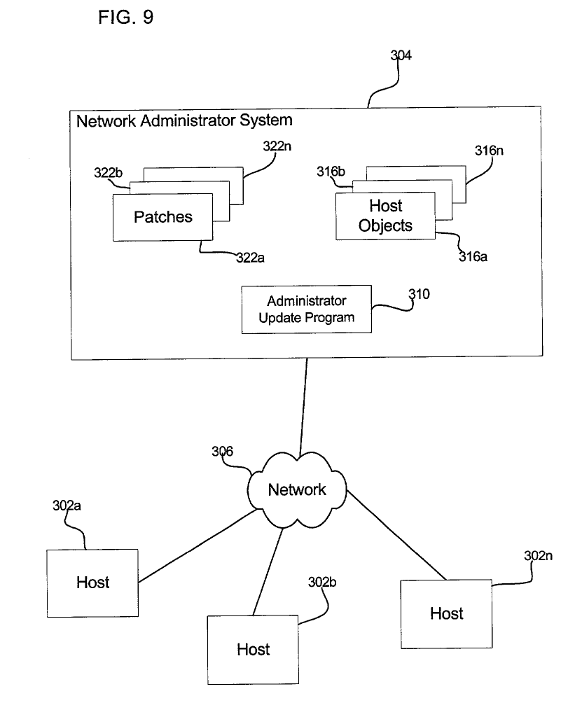

FIG. 9 illustrates an additional implementation in which multiple hosts 302a, b . . . n are managed by a network administrator system 304. In such implementations, the network administrator system 304 would maintain host objects 316a, b . . . n for each host 302a, b . . . n, respectively, managed by the network administrator 304 over the network 306. The network administrator 304 may have initialized the host objects 316a, b . . . n using the base data detector 12 which runs locally on the hosts 302a, b . . . n and/or the interactive detector 14. With respect to the interactive detector 14, the network administrator may use the interactive detector 14 to specify the configuration of the hosts 302a, b . . . n in the network 306.

The network administrator may run an administrator update program 310 to download or otherwise access patches 322a, b . . . n and their realization detectors, and then run the detector programs in the downloaded realization detectors to determine the patches that may be applied to the hosts 302a, b . . . n on the network 306. The network administrator, using the network update program 310, may then select which compatible patches to apply to the hosts 302a, b . . . n in the network. Additionally, the network administrator may maintain all hosts 302a, b . . . n with the same configuration. In such case, network administrator selection of patches to apply may cause the network update program 310 to apply the selected patches to all the hosts 302a, b . . . n in the network 302 represented by a host object 316a, b . . . n in the network administrator system 304.

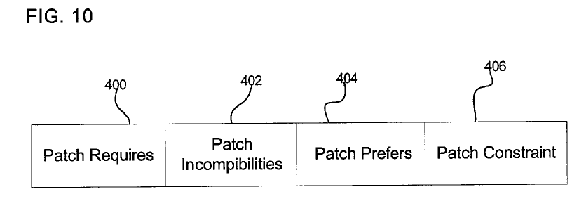

With the network implementation described with respect to FIG. 10, the network administrator does not have to interrogate or query the different hosts 302a, b . . . n, and may instead determine patches to apply using only the host objects 316a, b . . . n. In this way, the described implementations provide a tool to facilitate the application of patches to multiple hosts 302a, b . . . n managed by a common network administrator.

### Patch Expression Language

As discussed each patch 22a, b . . . n includes patch expressions 26 comprising a script that when executed processes the configuration information 50 and realizations 52 in the host object 16 to determine whether the patch 22a, b . . . n should be applied to the host 2. FIG. 11 provides attribute statements used to determine attributes of the installation of a patch 22a, b . . . n to the host 2, where the patch expressions 26 provided with a target patch 22a, b . . . n may include one or more of the attribute statements to determine attributes of the installation of the patch 22a, b . . . n to the host 2 given the host configuration.

PATCH REQUIRES 400: is called with one or more conditional statements, where each conditional statement is associated with one list of patches, wherein the patches in the list associated with the conditional statement evaluating as true must be installed on the host 2 in order to apply the patch 22a, b . . . n.

PATCH INCOMPAT 402: is called with one or more conditional statements, where each conditional statement is associated with one list of patches, wherein the patch 22a, b . . . n cannot be applied to the host 2 if the host 2 includes the patches in the list associated with the conditional statement evaluating as true.

PATCH PREFERS 404: is called with one or more conditional statements, where each conditional statement is associated with one list of patches, wherein the patches in the list associated with the conditional statement evaluating as true are preferred, but not required, to be installed on the host 2 when applying the patch 22a, b . . . n.

PATCH CONSTRAINT 406: is called with one or more conditional statements, wherein the patch 22a, b . . . n cannot be installed on the host 2 if the conditional statements are evaluated as true, i.e., the installation of the target patch is inappropriate if the evaluation returns a non-zero value, else if zero is returned, then installation is appropriate on the target host 2.

Each of the above attributes 400, 402, and 404 may be called with one or more patch IDs as parameters, where the installation attribute is satisfied, if the one or more specified patch IDs are installed on the host 2, e.g., PATCH_REQUIRES=001345-03. The attributes 400, 402, and 404 include conditional expressions that evaluate one or more states or conditions in the host 2, e.g., the presence of an installed hardware and/or software component, and echo a list of one or more patches if one conditional statement returns true. If the echoed list of patches are present in the host 2, as indicated in the installed patches 44 of the host object 16, then the attribute 400, 402, 404 applies to installation of the patch 22a, b . . . n on the host 2. The below expression provides an example of the format of the PATCH_REQUIRES 400 attribute.

PATCH_REQUIRES=(If isOSVersion 5.6; then echo “100345-09 112220-01”; fi)

The above attribute statement specifies that the patches following the “echo”, i.e, the echoed patch list, must be installed on the host 2 if the operating system version is 5.6 in order for the target patch 22a, b . . . n to properly install. Note that a series of PATCH_REQUIRES expressions used with different conditional statements and patch lists indicate different patches that are required in the host 2 for different configurations indicated in the host object 16.

The constraint attribute 406 does not echo a patch list and instead uses one or more conditional statements, that if evaluated as true indicates the attribute that the target patch 22a, b . . . n can be installed on the host. The conditional statements query the host object 16 for information on the availability of particular hardware and software resources 50, and/or realizations 30a, b . . . n, and return a true/false boolean value. Following are the conditional statements that may be used in the attribute statements 400, 402, 404, 406.

isOperatingSystem: returns true if the target host 2 operating system as indicated in the host object 16 is the same as the specified operating system (OS), else returns false.

isOSVersion: returns true if the target host 2 operating system as indicated in the host object 16 is of the specified release, else returns false.

isPlatform returns true if the target host 2 hardware platform as indicated in the host object 16 is the same as the specified platform, else returns false.

isArchitecture: returns true if the target host 2 processor architecture as indicated in the host object 16 is the same as the specified processor architecture, else returns false.

hasExactRealization: returns true if the verified flag 74 (FIG. 4) for the realization 52a, b . . . n in the realization list 50 having the same realization name 60 and same version number 62 as the specified realization is set to “1”; otherwise returns false.

hasRealization: returns true if the verified flag 74 (FIG. 4) for the realization 52a, b . . . n in the realization list 50 having the same realization name 60 and a same or higher version number 62 as the specified realization is set to “1”; otherwise returns false.

hasExactSoftwarePackage: returns true if the installed software information 42 in the target host object 16 indicates an installed software package having the same name and version number as specified software package.

hasSoftwarePackage: returns true if the installed software information 42 in the target host object 16 indicates an installed software package having the same name and a same or newer version number as the specified software package.

hasExactPatchID: returns true if the installed patches information 44 in the target host object 16 indicates an installed patch having the same name and a same version number as specified patch ID.

hasPatchID: returns true if the installed patches information 44 in the target host object 16 indicates an installed patch having the same name and a same or newer version number as specified patch ID.

The above methods are included in the constraint attribute 406 to determine whether the target patch 22a, b . . . n is compatible with the host 2 system. The above methods may also be used with the other attributes 400, 402, 404 to determine whether the patches in a list associated with the conditional statement evaluating as true is installed on the host 2, to determine whether the attribute defined by the attribute statement, e.g., requires, incompatible, prefers, applies to the installation of the target patch 22a, b . . . n to the host 2. After processing all the patch expressions 26 comprising one or more of the attributes 400, 402, 404, and 406 associated with a patch 22a, b . . . n and information in the host object 16, the end result is a true or false value indicating whether the patch code 24 may be installed on the host 2.

With the described patch expression statements and attributes, a software vendor has substantial flexibility to dynamically determine whether the patch code 24 can be applied Further, the software vendor writing the patch may provide different requirements for different systems. For instance, the dependent base patches, i.e., the echoed patch list, that must be installed in the host 2 as specified in the PATCH_REQUIRES statement may vary depending on the software and/or hardware configuration of the host 2 as determined by the conditional statements. Below is an example of patch expressions 26 provided with a target patch 22a, b . . . n that dynamically determine dependencies and other attributes of the installation that must be satisfied in order for the target patch 22a, b . . . n to be installed:

PATCH_REQUIRES=(if hasSoftwarePkg SUNWvolu; then echo “113322-02 112444-02”; fi)

PATCH_REQUIRES=(if is OperatingSystem SunOS && IsOSVersion 5.2; then echo “113322-05 112444-07”; fi)

PATCH_INCOMPAT=(if is Architecture i86; then echo 112022-03; fi)

PATCH_PREFERS=(if isOSVersion 5.2; then echo 101378-18; elif

isOSVersion 5.1; then echo “103290-03 122232-06”; fi)

PATCH_CONSTRAINT=(is OperatingSystem SunOS && isOSVersion 4.1)

The first PATCH_REQUIRES statement requires that if the host 2 includes the SUNWvolu software package, then the host 2 must include base patches 113322, version 2 and 112444, version 2 in order for the target patch 22a, b . . . n to be installed. The second PATCH_REQUIRES statement requires that the host 2 includes base patches 113322, version 5 and 112444, version 7 if the operating system on the host 2 is the Sun Solaris operating system (SunOS), release 5.2.** The PATCH_INCOMPAT statement would prevent the target patch code 24 from being installed if the host architecture is an Intel Corporation chip (“i86”)** and if the host 2 includes the patch 112022, version 3, i.e., the target patch 22a, b . . . n is incompatible with a system having the Intel chip architecture and the patch 112022, version 3. The PATCH_PREFERS statements would return that base patch 101378, version 18 is a preferred installation if the operating system version is 5.2 and that base patch 103290, version 3 and 122232, version 6 are preferred base patches to include if the operating system version is 5.1. The PATCH_CONSTRAINT statement requires that the host 2 include the Solaris operating system, release 4.1 in order for the patch 22a, b . . . n to be installed. **Java and Solaris are trademarks of Sun Microsystems, Inc. Intel and Pentium II are trademarks of Intel Corporation; Microsoft is a trademark of the Microsoft Corporation; and Setup Factory is a trademark of the Indigo Rose Software Design Corporation.

As discussed, the patch attribute statements 400, 402, 404, and 406 may include multiple conditional statements. For the attributes 400, 402, and 404, the conditional statements included with the attribute statement may each include a list of different patches. The PATCH_CONSTRAINT attributes statement may include multiple conditional statements, such that all the conditions must be satisfied in order for the patch 22a, b . . . n to be applied to the host 2.

Thus, the above patch expressions may be used in any number of combinations and permutations to provide a flexible and dynamic determination of the appropriateness of applying a patch based on the host 2 software and hardware configurations as indicated in the host object 16.

Moreover, the patch expressions 26 may consider whether realizations are installed. For instance, the expression PATCH_REQUIRES (if hasRealization DiskArray.SunA5000; then echo 113222-02; fi) would check whether the host realization list 50 includes the realization that indicates that the Sun A5000 disk array is installed. If so, then the patch base code 113222, version 2 must be installed in order for the target patch 22a, b . . . n including the expression to run. This allows the patch expressions to consider the state specified by realizations 52a, b . . . n in the host realzation list 50, which are capable of indicating specific states of the host 2.

In one implementation, the patch expressions 26 utilize a syntax similar to a common shell language that would be understood by many system administrators and other users. For instance, the syntax used to represent the patch expressions may comprise a slight variation of the Bourne shell. The syntax is similar enough to a common used script language so users will be familiar with the command structure to easily use the patch expressions, but different enough so that the patch expression statements cannot execute on the host 2 operating system. The patch expression syntax is only understood by the host update program 10. Using a variation of a common syntax provides added security because a vendor could not include expressions in a patch 22a, b . . . n that could inadvertently or malevolently access or modify data and configuration information in the host 2. Instead, the patch expression syntax of the described implementations is restricted by the host update program 10 to accessing the host object 16.

### Additional Implementation Details

The described implementations may comprise a method, apparatus, program or article of manufacture using standard programming and/or engineering techniques to produce software, firmware, hardware, or any combination thereof. The programs defining the functions of the described implementations can be delivered to a computer via a variety of information bearing media, which include, but are not limited to, computer-readable devices, carriers, or media, such as a magnetic storage media, “floppy disk,” CD-ROM, a file server providing access to the programs via a network transmission line, wireless transmission media, signals propagating through space, radio waves, infrared signals, etc. Of course, those skilled in the art will recognize that many modifications may be made to this configuration without departing from the scope of the present invention. Such information bearing media, when carrying computer-readable instructions that direct the functions of the present invention, represent alternative implementations of the present invention.

In the described implementations, the host 2 and update server 4 comprised separate computer systems. In alternative implementations, the host and update server may comprise program entities implemented on the same computer platform.

In certain implementations, the update programs, realization detectors, and realization routines are implemented in an object oriented programming language, such as Java, C++, etc. Alternatively, the programs and code described herein may be implemented in a non-object oriented programming language.

The host 2 and update server 4 may use any communication or messaging protocol known in the art to communicate.

In the described implementations, one host object 16 maintained all the information on available hardware and software resources 50 and the realization list 52 (FIG. 4). Alternatively, such information may be distributed across multiple data objects maintained for the host 2.

In the described implementations, realizations 32a, b . . . n were added to the host realization list 50 in response to the detector program 36 verifying a state for the host 2 based on configuration information 40 in the host object 16. In alternative implementations, the host update program 10 may generate a user interface display in which the user selects particular configuration options. A Java Servlet, or other program, may maintain an association of the configuration options in the user interface and realization. Upon receiving user selection of configuration options, the Servlet would then add the associated realizations to the host realization list 50 in the host object 16. In this way, realizations are added to the host object 16 through a user interface.

In the described implementations, the host update program executed the realization detectors and determined patches to apply to the host computer locally. Alternatively, the host object 16 defining the host system 2 may be generated at another computer remotely where the realization detectors execute to determine remotely patches that can be applied to the host system 2. In such implementations, the host objects may be generated using the interactive detector 14 where a user at the remote system enters information on the hardware and software configuration to generate the host object 16.

The described implementations were used to determine patches of code that may be applied to already installed software or firmware components. Additionally, the above technique for determining the suitability of patches to apply may be used to determine the suitability of installing an entirely new program on the system or installing additional documentation. Accordingly, the term “patch” as used herein may apply to updating the host 2 with any program or data, such as updates, upgrades, fixes, new installations, documentation, etc.

Host objects 16 may be maintained and used for numerous patch installations or regenerated each time the host update program 10 is provided a group of patches to install.

In the described implementations, the detector programs 36 included in the realization detectors 26a, b . . . n are not allowed to write to any other parts of the host 2 outside of writing verification information to the host object 16. In alternative implementations, the realization detectors 26a, b . . . n may be provided access to other parts of the host 2. The preferred logic of FIGS. 5-8 describe specific operations occurring in a particular order. In alternative embodiments, certain of the logic operations may be performed in a different order, modified or removed and still implement preferred embodiments of the present invention. Morever, steps may be added to the above described logic and still conform to the preferred embodiments. Further, operations described herein may occur sequentially or certain operations may be processed in parallel.

The foregoing description of the preferred embodiments of the invention has been presented for the purposes of illustration and description. It is not intended to be exhaustive or to limit the invention to the precise form disclosed Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed:

1. A method for creating a patch including content to apply to a computer, comprising:
generating a script program including at least one patch attribute statement, wherein each patch attribute statement is called with at least one conditional statement that returns a list of one or more patches if the at least one conditional statement evaluates as true based on a presence of a software or hardware component indicated in a computer object for the computer on which the patch will be applied, and wherein an attribute defined for the attribute statement is associated with the installation of the patch to the computer if the computer includes the returned list of patches; and
associating the script program with the patch, wherein the script program executes and processes the computer object including information on installed software and hardware components to determine whether to install the patch on the computer based on attributes of the installation determined by the script program.

2. The method of claim 1, wherein the patch attribute statement is capable of comprising a patch requires statement, wherein the patch requires attribute indicates that the patches in the returned patch list must be installed in the computer in order for the patch to be installed in the computer.

3. The method of claim 1, wherein the conditional and patch attribute statements utilize a syntax that is similar to a syntax of commands capable of being interpreted by a command processor interface of the computer operating system, and wherein the syntax of the conditional and patch attribute statements prevent the conditional and patch attribute statements from executing on the computer outside of a patch update interpreter that is capable of interpreting the syntax of the conditional and patch attribute statements.

4. The method of claim 1, wherein the patch attribute statements included in the script program are capable of including patch attribute statements that are members of the set of patch attribute statements comprising:
a patch incompatible statement, wherein the patch incompatible attribute indicates that if the patches in the returned patch list are installed in the computer, then the patch cannot be installed in the computer; and
a patch prefers statement, wherein the patch prefers attribute indicates that the patches in the returned patch list are recommended to be installed in the computer.

5. The method of claim 1, wherein the patch attribute statements are further capable of including a patch constraint attribute called with at least one conditional statement, wherein the patch constraint attribute indicates that the patch can be installed in the computer if each conditional statement evaluates as true.

6 The method of claim 1, wherein the conditional statements provided with the attribute statements are members of the set of conditional statements comprising:
a first conditional statement that determines whether the computer object indicates that a specified vendor operating system is installed on the computer;
a second conditional statement that determines whether the computer object indicates that a specified version of the operating system is installed on the computer;
a third conditional statement that determines whether the computer object indicates that the computer includes a specified hardware platform;
a fourth conditional statement that determines whether the computer object indicates that a specified software package having a specified version number is installed on the computer;
a fifth conditional statement that determines whether the computer object indicates that a specified software package having a specified version number or higher is installed on the computer;
a sixth conditional statement that determines whether the computer object indicates that a specified patch having a specified version number is installed on the computer;
a seventh conditional statement that determines whether the computer object indicates that a specified patch package having a specified version number or higher is installed on the computer; and
an eighth conditional statement that determines whether the computer object indicates that the computer includes a specified architecture.

7. The method of claim 1, wherein the computer object is further capable of indicating a realization that defines a state of the computer, wherein the conditional statements are further capable of determining whether realizations are included in the computer object indicating the presence of the defined realization states at the computer, wherein the attribute defined for the patch attribute statement is associated with the installation of the patch to the computer if the at least one conditional statement is evaluated as true.

8. The method of claim 1, wherein the patch attribute statement includes multiple conditional statements and a different list of patches for each conditional statement, wherein the attribute defined for the attribute statement is associated with the installation of the patch to the system if the system includes the returned list of patches for the conditional statement that evaluated as true.

9. A system for determining whether to apply a patch including content onto a computer, comprising:
a processor;
a computer readable medium including a computer object including information on installed software and hardware components determined in the computer
an interpreter program capable of interpreting:
(i) a set of conditional statements that return a boolean response based on a presence of a software or hardware component indicated in the computer object for the computer on which the patch will be applied;
(ii) a patch attribute statement called with at least one conditional statement that returns a list of one or more patches if the at least one conditional statement evaluates as true, wherein a attribute defined for the attribute statement is associated with the installation of the patch to the computer if the computer includes the returned list of patches; and
(iii) a script program including at least one patch attribute statement, wherein the script program statements and computer object are processed to determine whether the at least one conditional statement associated with each patch attribute statement is true and, if so, whether the patches in the returned list are included in the computer.

10. The system of claim 9, wherein the interpreter program is further capable of interpreting a patch requires statement, wherein the patch requires attribute indicates that the patches in the returned patch list must be installed in the computer in order for the patch to be installed in the computer.

11. The system of claim 9, wherein the conditional and patch attribute statements are implemented in a syntax that is similar to a syntax of commands capable of being interpreted by a command processor interface of the computer operating system, and wherein the syntax of the conditional and patch attribute statements capable of being interpreted by the program interpreter are not capable of being interpreted by the command processor interface.

12. The system of claim 9, wherein the interpreter program is further capable of interpreting patch attribute statements that are members of the set of patch attribute statements comprising:
a patch incompatible statement, wherein the patch incompatible attribute indicates that if the patches in the returned patch list are installed in the computer, then the patch cannot be installed in the computer; and
a patch prefers statement, wherein the patch prefers attribute indicates that the patches in the returned patch list are recommended to be installed in the computer.

13. The system of claim 9, wherein the interpreter program is further capable of interpreting a patch constraint attribute called with at least one conditional statement, wherein the patch constraint attribute indicates that the patch can be installed in the computer if each conditional statement evaluates as true.

14 The system of claim 9, wherein the conditional statements provided with the attribute statements are members of the set of conditional statements comprising:
a first conditional statement that determines whether the computer object indicates that a specified vendor operating system is installed on the computer;
a second conditional statement that determines whether the computer object indicates that a specified version of the operating system is installed on the computer;
a third conditional statement that determines whether the computer object indicates that the computer includes a specified hardware platform;
a fourth conditional statement that determines whether the computer object indicates that a specified software package having a specified version number is installed on the computer;
a fifth conditional statement that determines whether the computer object indicates that a specified software package having a specified version number or higher is installed on the computer;
a sixth conditional statement that determines whether the computer object indicates that a specified patch having a specified version number is installed on the computer;
a seventh conditional statement that determines whether the computer object indicates that a specified patch package having a specified version number or higher is installed on the computer; and
an eighth conditional statement that determines whether the computer object indicates that the computer includes a specified architecture.

15. The system of claim 9, wherein the computer object is further capable of indicating a realization that defines a state of the computer, wherein the conditional statements are further capable of determining whether realizations are included in the computer object indicating the presence of the defined realization states at the computer, wherein the attribute defined for the patch attribute statement is associated with the installation of the patch to the computer if the at least one conditional statement is evaluated as true.

16. The system of claim 9, wherein the patch attribute statement includes multiple conditional statements and a different list of patches for each conditional statement, wherein the attribute defined for the attribute statement is associated with the installation of the patch to the system if the system includes the returned list of patches for the conditional statement that evaluated as true.

17. An article of manufacture including program code for determining whether to apply a patch including content to a computer by:
providing a computer object including information on software and hardware components in the computer;
interpreting a script program including at least one patch attribute statement, wherein each patch attribute statement is called with at least one conditional statement that returns a list of one or more patches if the at least one conditional statement evaluates as true based on a presence of a software or hardware component indicated in the computer object for the computer on which the patch will be applied, and wherein an attribute defined for the attribute statement is associated with the installation of the patch to the computer if the computer includes the returned list of patches; and
processing the computer object including information on installed software and hardware components when executing the script program to determine whether to install the patch on the computer based on attributes of the installation determined by the script program.

18. The article of manufacture of claim 17, wherein the patch attribute statement is capable of comprising a patch requires statement, wherein the patch requires attribute indicates that the patches in the returned patch list must be installed in the computer in order for the patch to be installed in the computer.

19. The article of manufacture of claim 17, wherein the conditional and patch attribute statements utilize a syntax that is similar to a syntax of commands capable of being interpreted by a command processor interface of the computer operating system, and wherein the syntax of the conditional and patch attribute statements prevent the conditional and patch attribute statements from executing on the computer outside of a patch update interpreter that is capable of interpreting the syntax of the conditional and patch attribute statements.

20. The article of manufacture of claim 17, wherein the patch attribute statements included in the script program are capable of including patch attribute statements that are members of the set of patch attribute statements comprising:
a patch incompatible statement, wherein the patch incompatible attribute indicates that if the patches in the returned patch list are installed in the computer, then the patch cannot be installed in the computer; and
a patch prefers statement, wherein the patch prefers attribute indicates that the patches in the returned patch list are recommended to be installed in the computer.

21. The article of manufacture of claim 17, wherein the patch attribute statements are further capable of including a patch constraint attribute called with at least one conditional statement, wherein the patch constraint attribute indicates that the patch can be installed in the computer if each conditional statement evaluates as true.

22 The article of manufacture of claim 17, wherein the conditional statements provided with the attribute statements are members of the set of conditional statements comprising:
a first conditional statement that determines whether the computer object indicates that a specified vendor operating system is installed on the computer;
a second conditional statement that determines whether the computer object indicates that a specified version of the operating system is installed on the computer;
a third conditional statement that determines whether the computer object indicates that the computer includes a specified hardware platform;
a fourth conditional statement that determines whether the computer object indicates that a specified software package having a specified version number is installed on the computer;
a fifth conditional statement that determines whether the computer object indicates that a specified software package having a specified version number or higher is installed on the computer;
a sixth conditional statement that determines whether the computer object indicates that a specified patch having a specified version number is installed on the computer;
a seventh conditional statement that determines whether the computer object indicates that a specified patch package having a specified version number or higher is installed on the computer; and
an eighth conditional statement that determines whether the computer object indicates that the computer includes a specified architecture.

23. The article of manufacture of claim 17, wherein the computer object is further capable of indicating a realization that defines a state of the computer, wherein the conditional statements are further capable of determining whether realizations are included in the computer object indicating the presence of the defined realization states at the computer, wherein the attribute defined for the patch attribute statement is associated with the installation of the patch to the computer if the at least one conditional statement is evaluated as true.

24. The article of manufacture of claim 17, wherein the patch attribute statement includes multiple conditional statements and a different list of patches for each conditional statement, wherein the attribute defined for the attribute statement is associated with the installation of the patch to the system if the system includes the returned list of patches for the conditional statement that evaluated as true.

25. A computer readable medium including data structures for determining whether to apply a patch including content to a computer, comprising:
a script program including at least one patch attribute statement, wherein each patch attribute statement is called with at least one conditional statement that returns a list of one or more patches if the at least one conditional statement evaluates as true based on a presence of a software or hardware components in the computer on which the patch will be applied, and wherein an attribute defined for the attribute statement is associated with the installation of the patch to the computer if the computer includes the returned list of patches, and wherein the script program and information on installed software and hardware components are processed to determine whether to install the patch on the computer based on attributes of the installation determined by the script program.

26. The computer readable medium of claim 25, wherein the patch attribute statement is capable of comprising a patch requires statement, wherein the patch requires attribute indicates that the patches in the returned patch list must be installed in the computer in order for the patch to be installed in the computer.

27. The computer readable medium of claim 25, wherein the conditional and patch attribute statements utilize a syntax that is similar to a syntax of commands capable of being interpreted by a command processor interface of the computer operating system, and wherein the syntax of the conditional and patch attribute statements prevent the conditional and patch attribute statements from executing on the computer outside of a patch update interpreter that is capable of interpreting the syntax of the conditional and patch attribute statements.

28. The computer readable medium of claim 25, wherein the patch attribute statements included in the script program are capable of including patch attribute statements that are members of the set of patch attribute statements comprising:
a patch incompatible statement, wherein the patch incompatible attribute indicates that if the patches in the returned patch list are installed in the computer, then the patch cannot be installed in the computer; and
a patch prefers statement, wherein the patch prefers attribute indicates that the patches in the returned patch list are recommended to be installed in the computer.

29. The computer readable medium of claim 25, wherein the patch attribute statements are further capable of including a patch constraint attribute called with at least one conditional statement, wherein the patch constraint attribute indicates that the patch can be installed in the computer if each conditional statement evaluates as true.

30 The computer readable medium of claim 25, wherein the conditional statements provided with the attribute statements are members of the set of conditional statements comprising:
a first conditional statement that determines whether the computer object indicates that a specified vendor operating system is installed on the computer;
a second conditional statement that determines whether the computer object indicates that a specified version of the operating system is installed on the computer;
a third conditional statement that determines whether the computer object indicates that the computer includes a specified hardware platform;
a fourth conditional statement that determines whether the computer object indicates that a specified software package having a specified version number is installed on the computer;
a fifth conditional statement that determines whether the computer object indicates that a specified software package having a specified version number or higher is installed on the computer;
a sixth conditional statement that determines whether the computer object indicates that a specified patch having a specified version number is installed on the computer;
a seventh conditional statement that determines whether the computer object indicates that a specified patch package having a specified version number or higher is installed on the computer; and
an eighth conditional statement that determines whether the computer object indicates that the computer includes a specified architecture.

31. The computer readable medium of claim 25, wherein the computer object is further capable of indicating a realization that defines a state of the computer, wherein the conditional statements are further capable of determining whether realizations are included in the computer object indicating the presence of the defined realization states at the computer, wherein the attribute defined for the patch attribute statement is associated with the installation of the patch to the computer if the at least one conditional statement is evaluated as true.

32. The computer readable medium of claim 25, wherein the patch attribute statement includes multiple conditional statements and a different list of patches for each conditional statement, wherein the attribute defined for the attribute statement is associated with the installation of the patch to the system if the system includes the returned list of patches for the conditional statement that evaluated as true.
